(19) United States
(12) Patent Application Publication
(10) Pub. No.: US 2008/0117108 A1
(43) Pub. Date: May 22, 2008

(54) MINIATURE ANTENNA WITH FEEDING COUPLED LINE

(75) Inventor: Sheng Ming Deng, Hsinchu County (TW)

Correspondence Address: WPAT, PC;INTELLECTUAL PROPERTY ATTORNEYS, 2030 MAIN STREET, SUITE 1300, IRVINE, CA, 92614, US

(73) Assignees: WAVEFAR TECHNOLOGY CO., LTD, Hsinchu (TW); WAVERAY TECHNOLOGY CORP., Hsinchu County (TW)

(21) Appl. No.: 11/941,878

(22) Filed: Nov. 16, 2007

(30) Foreign Application Priority Data
Nov. 22, 2006 (TW) 095220551

(51) Int. Cl. H01Q 1/38

(52) U.S. Cl. 343/700 MS

(57) ABSTRACT

The present invention provides a micro antenna with feeding coupled line comprising a dielectric body, an antenna metal surface, a ground metal surface, and a feeding line. The ground metal surface is to couple the antenna metal surface and the feeding line for signal transmitting; namely, the ground metal surface and the feeding line form a feeding coupled line. The antenna metal surface, the feeding line, and the ground metal surface are set on the surface of the dielectric body. The dielectric body can be a rectangular parallelepiped made of ceramic materials. The feeding line and the ground metal surface can be set on the same surface or on different surfaces of the rectangular parallelepiped. The length of the antenna metal surface is one quarter of the wavelength of the transmitting and receiving signals multiplied by an integer.

### BACKGROUND OF THE INVENTION

1. Field of the Invention

The present invention relates to an antenna, and more particularly, to a micro antenna with feeding coupled line.

2. Description of the Related Art

With the development of the wireless communication technology, cell phones have become the most important communication device for most people, and wireless local area network (WLAN) has been booming as well. As the main component for signal transmitting and receiving, antennas have evolved into many types and forms, but the main goal is to seek for the best signal transmitting and receiving performance. In addition, for a mobile device to be easy to carry and hold, the antenna with a smaller size has the advantage over the large one.

Therefore, to improve the portability of the mobile devices, miniaturization of the mobile devices and their components has become the trend of wireless communication nowadays. One of the solutions for antennas is for them to be made of dielectric materials. In other words, an antenna made of medium with a higher dielectric constant can be made smaller to achieve the goal of miniaturization.

There are many kinds of antennas in application, and some of them are too complicate that the costs are too high. Therefore a micro antenna with simple structure and high performance is one of the best solutions of wireless transceiver device.

### SUMMARY OF THE INVENTION

The present invention is to provide a micro antenna with feeding coupled line, which is especially suitable for wireless portable communication devices due to its small size.

The present invention provides a micro antenna with feeding coupled line, comprising a dielectric body, an antenna metal surface, a ground metal surface, and a feeding line. The ground metal surface is to couple the antenna metal surface and the feeding line for signal transmitting; namely, the ground metal surface and the feeding line form a feeding coupled line. The antenna metal surface, the feeding line, and the ground metal surface are set on the surface of the dielectric body.

The dielectric body can be a rectangular parallelepiped made of ceramic materials. The feeding line and the ground metal surface can be set on the same surface or on different surfaces of the rectangular parallelepiped. The length of the antenna metal surface is one quarter of the wavelength of the transmitting and receiving signals multiplied by an integer.

### BRIEF DESCRIPTION OF THE DRAWINGS

The invention will be described according to the appended drawings in which:

FIG. 1 is the schematic view of a micro antenna with feeding coupled line of one embodiment of the present invention;

FIG. 2 is the schematic view of a micro antenna with feeding coupled line of another embodiment of the present invention; and

FIG. 3 is the schematic view of a micro antenna with feeding coupled line of yet another embodiment of the present invention.

### DETAILED DESCRIPTION OF THE INVENTION

The principle of the present invention is to set a feeding line, an antenna metal surface, and a ground metal surface on the surface of the dielectric body. By signal coupling, the signal of the feeding line and the antenna metal surface is transmitted by the ground metal surface. That is, the ground metal surface and the feeding line form a feeding coupled line.

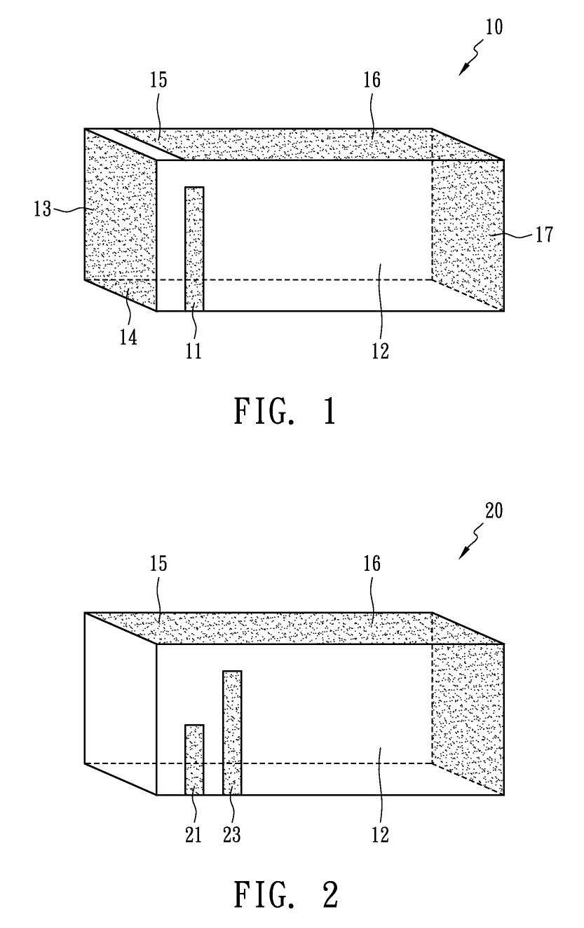

FIG. 1 is the schematic view of a micro antenna with feeding coupled line of one embodiment of the present invention. The micro antenna 10 comprises a dielectric body, which is a rectangular parallelepiped made of ceramic materials, a feeding line 11 set on the lateral surface 12 of the rectangular parallelepiped, and a ground metal surface 13 set on the surface 14. In addition, an antenna metal surface 15 is set on the surface 16 and extends to another surface 17. There is a gap between the antenna metal surface 15 and the ground metal surface 13. The length of the antenna metal surface 15 is approximately a quarter of the wavelength of the transmitting and the receiving signal multiplied by an integer. There is also a gap between the antenna metal surface 15 and the feeding line 11. The feeding line 11 and the ground metal surface 13 form a feeding coupled line; that is, the feeding line 11 couples with the antenna metal surface 15 by the ground metal surface 13 to transmit signal.

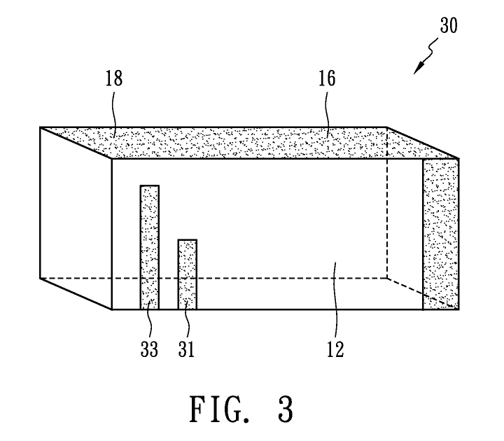

FIG. 2 is the schematic view of a micro antenna with feeding coupled line of another embodiment of the present invention. The micro antenna 20 is approximately the same as the micro antenna 10, while the difference is that the ground metal surface is now on the lateral surface; that is, a feeding line 21 and a ground metal surface 23 are set on the same surface 12. Likewise, the feeding line 21 couples with the antenna metal surface 15 by the ground metal surface 23 to transmit signal.

FIG. 3 is the schematic view of a micro antenna with feeding coupled line of yet another embodiment of the present invention. The micro antenna 30 also has a feeding line 31 and a ground metal surface 33 set on the surface 12, while a antenna metal surface 18 is not only set on the surface 16, but also extends downward on the right side of surface 12.

One can configure the antenna metal surface to be connected with or disconnected with the ground according to the signal frequency. Generally, in low frequency, the antenna metal surface is connected with the ground, and in high frequency, the antenna metal surface is not.

The dimensions of the embodiments of the micro antennas with feeding coupled line above are 13×5×3 mm, wherein the dimensions can be adjusted according to the dielectric constant of the dielectric body. Generally, the higher the dielectric constant of the dielectric body is, the smaller the size of the antenna can be. In addition, the embodiments of the present invention are applied to global positioning system (GPS) with frequency 1.575 GHz. However, the embodiments described above are intended to explain the characteristic of the present invention, not to constrain its dimensions or applications. In practical applications, numerous alternatives can be made on the antenna metal surface, the feeding line, and the ground metal surface, but whatever devices utilize the present invention of transmitting signal by coupling the feeding coupled line (including ground metal surface and feeding line) and the antenna metal surface should still fall within the scope the present invention.

The above-described embodiments of the present invention are intended to be illustrative only. Numerous alternative embodiments may be devised by those skilled in the art without departing from the scope of the following claims.

What is claimed is:

1. A micro antenna with feeding coupled line, comprising:
a dielectric body;
an antenna metal surface;
a feeding line; and
a ground metal line configured to couple and transmit signals between the antenna metal surface and the feeding line;
wherein the antenna metal surface, the feeding line and the ground metal line are set on surfaces of the dielectric body.

2. The micro antenna of claim 1, wherein the dielectric body is a rectangular parallelepiped.

3. The micro antenna of claim 1, wherein there is a gap between the feeding line and the antenna metal surface.

4. The micro antenna of claim 2, wherein the feeding line and the ground metal line are on the same surface of the rectangular parallelepiped.

5. The micro antenna of claim 2, wherein the feeding line and the ground metal line are on different surfaces of the rectangular parallelepiped.

6. The micro antenna of claim 2, wherein the antenna metal surface is on two surfaces of the rectangular parallelepiped.

7. The micro antenna of claim 1, wherein antenna metal surface is connected to ground.

8. The micro antenna of claim 1, wherein the length of the antenna metal surface is a quarter of the wavelength of the transmitting and receiving signal multiplied by an integer.

9. The micro antenna of claim 1, wherein the ground metal surface and the feeding line form a feeding coupled line.

10. The micro antenna of claim 1, wherein the dielectric body is made of ceramic materials.
